(19) United States
(12) Patent Application Publication
(10) Pub. No.: US 2009/0132637 A1
(43) Pub. Date: May 21, 2009

(54) INFORMATION RECOGNITION SYSTEM

(75) Inventor: Haru ANDO, Kodaira (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/275,559

(22) Filed: Nov. 21, 2008

(30) Foreign Application Priority Data
Nov. 21, 2007 (JP) 2007-301167

(51) Int. Cl. G06F 15/16

(52) U.S. Cl. 709/201

(57) ABSTRACT

The invention, taking an electronic content utilization casing as the basis, extracts input activity to the same casing; estimates data input positions within the content by calculating similarity values and difference values among the same activity data, and similarity values and difference values between the activity data and model data; estimates the input state of the user from the estimated input positions; and presents the same estimation values as the content utilization state.

### INCORPORATION BY REFERENCE

The present application claims priority from Japanese application JP2007-301167 filed on Nov. 21, 2007, the content of which is hereby incorporated by reference into this application.

### BACKGROUND OF THE INVENTION

The present invention pertains to an information recognition system that estimates, from information that is input into content in a time zone in which the content is being utilized, the format of the utilized content, and gets a grasp of the content utilization state.

Accompanying the recent spread of broadband networks, extensive media content such as Web content is in the process of spreading. E.g., surveys on the Web are carried out in numerous portal services and are essential as a function to collect information about individual users, so if it is possible to conduct surveys with users that are able to use the Internet, information can be collected in a global way.

On the other hand, conducting surveys using paper is a method that has existed for some time, and even though it has drawbacks like requiring time for retrieval, it is a method that is used for the most part even at present.

However, no matter whether it is a survey using content on the Internet using the Web or a survey carried out using paper, there is a need to collect and analyze the entered, or filled out, data in order to grasp the tendency of the whole.

In this case, at present, first in the case of Web content, a reply number tag is conferred each text box into which survey reply information is entered and, on the basis of the same tag number, data entered into text boxes with the same tag number are considered to be replies to the same question and totalization and analysis thereof are carried out.

On the other hand, in the case of surveys which are filled out on paper, the person in charge of totalizing the replies written on paper reads the contents of the replies to carry out totalization and analysis. Regarding the latter, in recent years, the positional and time data written down on the paper sheet are read by means of a pen system called a “digital pen” which has the function of being able to acquire positional data written on paper, the system being devised so as to be able to store the information electronically, and in this case, reply entry fields are set on the paper sheet and data entered inside the same fields are considered to be reply data and are totalized and analyzed.

Also, as a conventional analytical technique, in the case of Web content, there is the function, using the times at which entries were carried out with respect to text boxes for reply input which are set inside the same content, of extracting the sequence of replies with respect to each of the questions of the survey and using the entered contents, of performing operations like judging the accuracy of the contents (JP-A-2002-149048, JP-A-2004-229948 (US 2004/0152060), and JP-A-2005-352877). Moreover, in the case of content for which entry is carried out utilizing a digital pen, there is, regarding the entered contents, a function of performing operations like extracting the reply sequence by means of the entry times with respect to the reply entry fields such as mentioned above, and judging the accuracy of the contents by using character recognition technology or the like (JP-A-2004-265272 and JP-A-2004-127197).

### SUMMARY OF THE INVENTION

The inventions disclosed in JP-A-2002-149048, JP-A-2004-229948 (US 2004/0152060), and JP-A-2005-352877 carry out evaluation of manipulation-type learning by comparing and analyzing the PC manipulation log of the learner, recorded during learning, and correct response manipulation data, with respect to e.g. educational PC Web content or an interface under evaluation.

However, in each entry place of the content or interface under consideration, there is incorporated a function of acquiring the entered data, and by the fact that this function is incorporated, it becomes possible to acquire the entry contents and time. Consequently, for acquisition of the entered contents, it is necessary to incorporate this function in each entry place, but it is difficult to incorporate the present function in all the required content.

Also, the devices of JP-A-2004-265272 and JP-A-2004-127197 acquire handwritten information using a digital pen and judge the accuracy of the handwritten contents from the handwritten information recorded inside the handwriting field. However, even in this case, there is a need to register in advance the fields which should be filled out by hand, it being normal for the same registration to require some time. As a result, it is not possible to perform operations like extracting or visualizing the user entry processes regarding extensive data in a short time, so sufficient functionality cannot be realized.

Among the inventions disclosed in the present application, a brief explanation of the outline of a representative one would be as follows. Taking as the basis an electronic content utilization casing such as a Personal Computer or a cellular phone, the input activity (input and output of data (input text, display contents)) to the casing is extracted, and by calculating similarity values and difference values among the same activity data, or similarity values and difference values between the activity data and model data, the data input position within the content is estimated, the input state of the user is estimated from the estimated input position, and the same estimate is presented as the content utilization state.

According to the present invention, it is possible to estimate the content utilization state of the user from the information that is input and output while the user is utilizing content, without being aware of the user or the content format, and to carry out an evaluation of the developed content. Also, since it is possible to conveniently and swiftly carry out an evaluation with respect to extensive content, it becomes possible to bring out the utilized result as is and swiftly construct a development guideline for Web content or other content. Moreover, since it is possible to get a grasp of the content preferences and utilization propensity of the user itself, the result is that information that is necessary for the user can be provided appropriately.

Other objects, features and advantages of the invention will become apparent from the following description of the embodiments of the invention taken in conjunction with the accompanying drawings.

### BRIEF DESCRIPTION OF THE DRAWINGS

FIG. 1 is an example of a block diagram showing a system configuration of an embodiment of the present invention.

FIG. 2 is an example of a block diagram showing the configuration of a data management and analysis server 101.

FIG. 3 is an example of a block diagram showing the configuration of a digital pen server 102.

FIG. 4 is an example of a block diagram showing the configuration of a user terminal.

FIG. 5 is an example of a block diagram showing the configuration of a content evaluator terminal.

FIGS. 6A and 6B are respectively input screens of a user terminal and a content evaluator terminal.

FIG. 7 is an example of an event input flow (Web format) classified by content type.

FIG. 8 is an example of an event input flow (digital pen utilization) classified by content type.

FIG. 9 is an example of a browsing screen of a user terminal.

FIG. 10 is an example of a browsing screen of a content evaluator terminal.

FIG. 11 is an example of a browsing screen of Web format content.

FIG. 12 is an example of a browsing screen of digital pen format content.

FIG. 13 is an example of processing in a user terminal.

FIG. 14 is an example of a process flow in a content evaluator terminal.

FIG. 15 is an example of an analysis process flow in a user event data analysis program 1010204.

FIG. 16 is an example of an event analysis flow based on a format estimation program for a digital pen and an event field transfer process recognition program.

FIG. 17 is an example of an analysis result display flow based on an analysis result display program on a data management and analysis server.

### DETAILED DESCRIPTION OF THE EMBODIMENTS

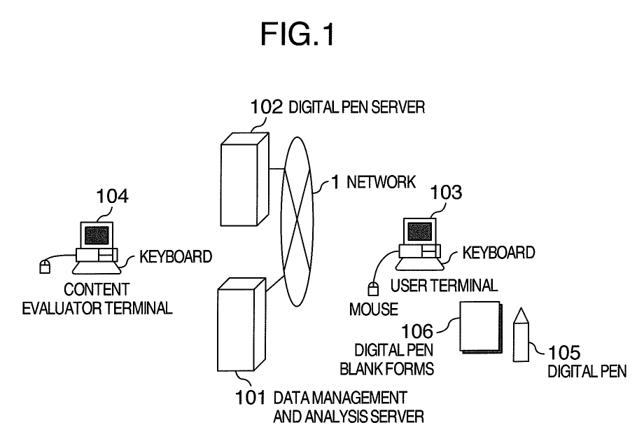

A content free format recognition device, which is a mode of implementing the present invention, is shown in FIG. 1.

First, a mention will be made regarding a system configuration example and a functional example. The present system is, as shown in FIG. 1, configured in a client server form and, as server environment units, there are a data management and analysis server 101 carrying out content management and data analysis and a digital pen server 102 utilized in the case of using paper content.

On the other hand, as client environment units, there are a user terminal PC 103, a content evaluator terminal PC 104, a digital pen 105, and digital pen blank forms 106. In data management and analysis server 101, content database management, user registration and management, communication processing with the client software, and event analysis processing are carried out.

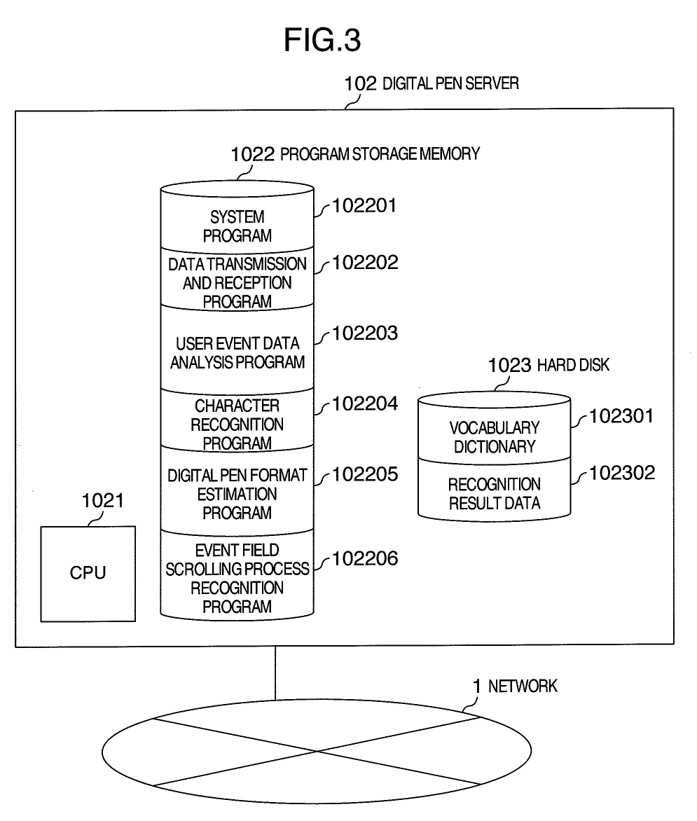

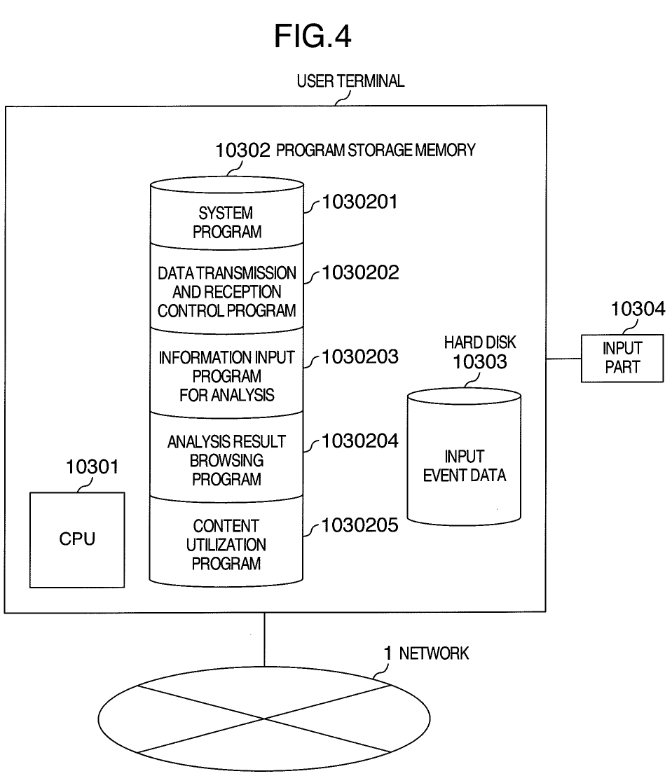

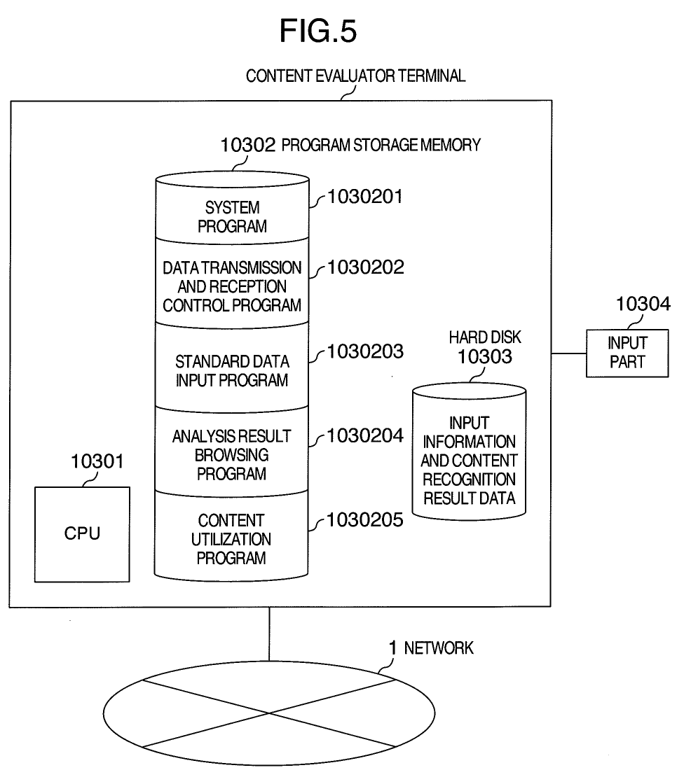

As for digital pen server 102, there are, as shown in FIG. 3, a CPU (Central Processing Unit) 1021 and a program storage memory 1022. In the present memory, there are mounted a system program 102201, a data transmission and reception program 102202, a user event data analysis program 102203, a character recognition program 102204, a format estimation program for digital pens 102205, and an event field transfer process recognition program 102206. Further, on a hard disk 1023, there is a vocabulary dictionary 102301 and recognition result data 102302.

The present server has functions of storing and analyzing digital pen information obtained as a result of utilizing digital pen 105 and digital pen blank forms 106 set in the client environment and transmits the analysis results to data management and analysis server 101.

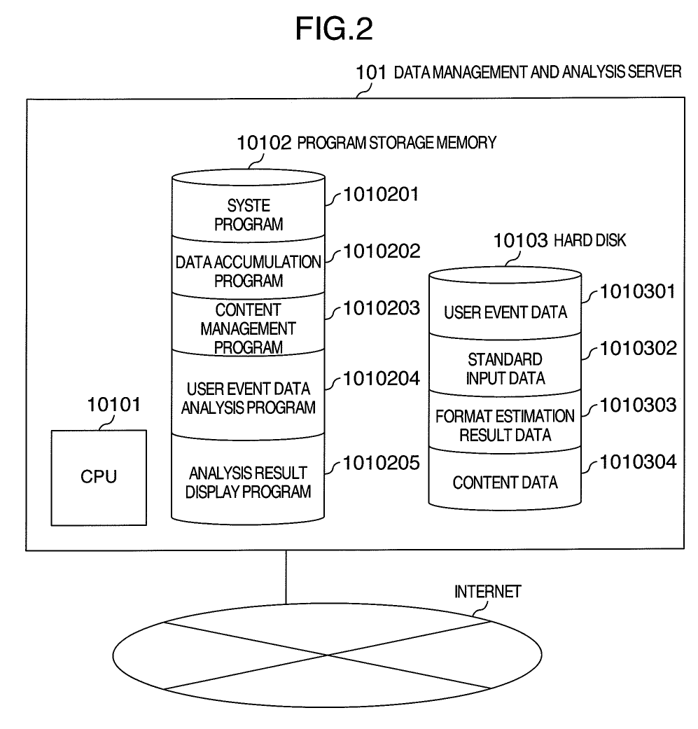

In data management and analysis server 101, as shown in FIG. 2, there are mounted a CPU 10101, a program storage memory 10102, and a hard disk 10103. The programs loaded in the program storage memory are a system program 1010201, a data accumulation program 1010202, a content management program 1010203, a user event information analysis program 1010204, and an analysis result display program 1010205. Also, the data stored in hard disk 10103 are user event data 1010301, standard input data 1010302, format estimation result data 1010303, and content data 1010304.

The role of the data management and analysis server of the present invention is, mainly, by using user event information analysis program 1010204, to analyze the event information, transmitted from the client PC, which is a plurality of reply results for each content item, with a focus on the event log type, the event generation position, and the event generation time, and to extract a user event generation field, assuming that a field duplicated by the event generation is a field designated as a user input field. Further, it is to carry out a comparison of the input contents in the user event generation field and, taking it as an objective that the information pieces are identical, to carry out matching of user event data 1010301, which are text input information generated in the generation field, and standard reply data that are input as standard data on the client side and extract the following reply contents and processes.

As reply contents and processes handled in user individual units, there are computed (a) the accuracy of the response, (b) the required response time, (c) the response sequence, and (d) the number of responses and, handled as a group, there are computed (a) the reply accuracy ratio, (b) the distribution of required reply times for each question, (c) the reply sequence tendency (pattern classification), and (d) the distribution of the number of replies.

Regarding input based on a keyboard and a mouse, the reply accuracy and the accurate reply ratio are found by carrying out, by means of a text analysis program which is a subprogram of the user event analysis program, a text analysis of the information which is input by individual users into the position which is estimated to be the user event generation field and matching any identical vocabulary words or sentences that are present.

On the other hand, in case the input has not been carried out with a digital pen, user event data 1010301, which are pieces of digital pen input information generated in the user event generation field, are recognized by loading a character recognition function, and a means of converting the text information is used.

Regarding the client side, user terminal 103 and content evaluator terminal 104 as well as digital pen 105 and digital pen blank forms 106 are set as the equipment utilized by the user utilizing content.

The PC and digital pen, which are user terminals, and the PC and digital pen, which are content evaluator terminals, are e.g. connected by USB, the data entered with a digital pen being transmitted to the digital pen server via each of the PCs.

Data other than user event data that are generated by each PC are transmitted from each PC to data management and analysis server 101. Here, in case correct replies are needed for a test or the like or in case differences from standard responses in a survey are extracted, the content evaluator can e.g. register separate correct responses and standard responses in each user event generation field and extract the differences from the actual replies. If selection of content, execution of the standard response input of each content item, event recording at the time of execution and comment input to each content item are carried out, the result thereof is transmitted to the server. As a standard response, it is possible to input standard responses with several patterns.

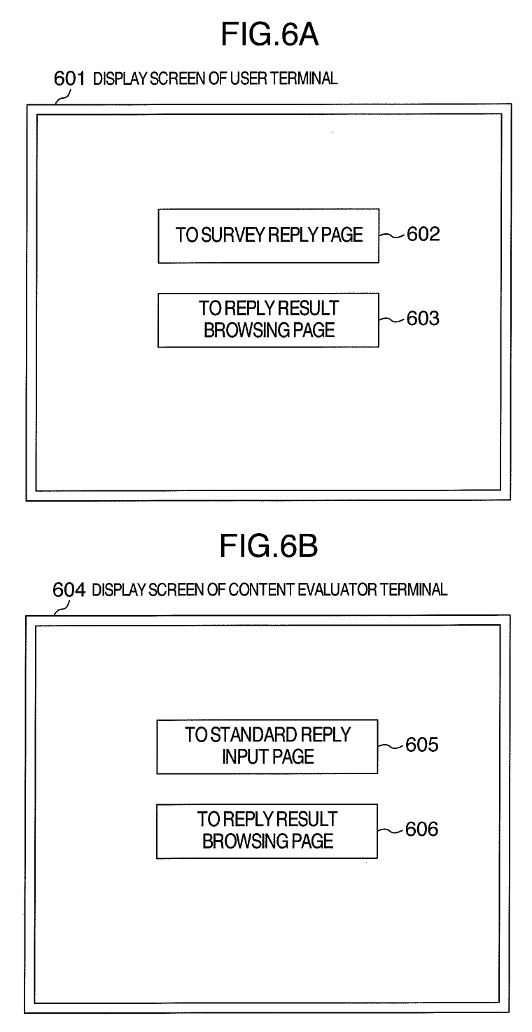

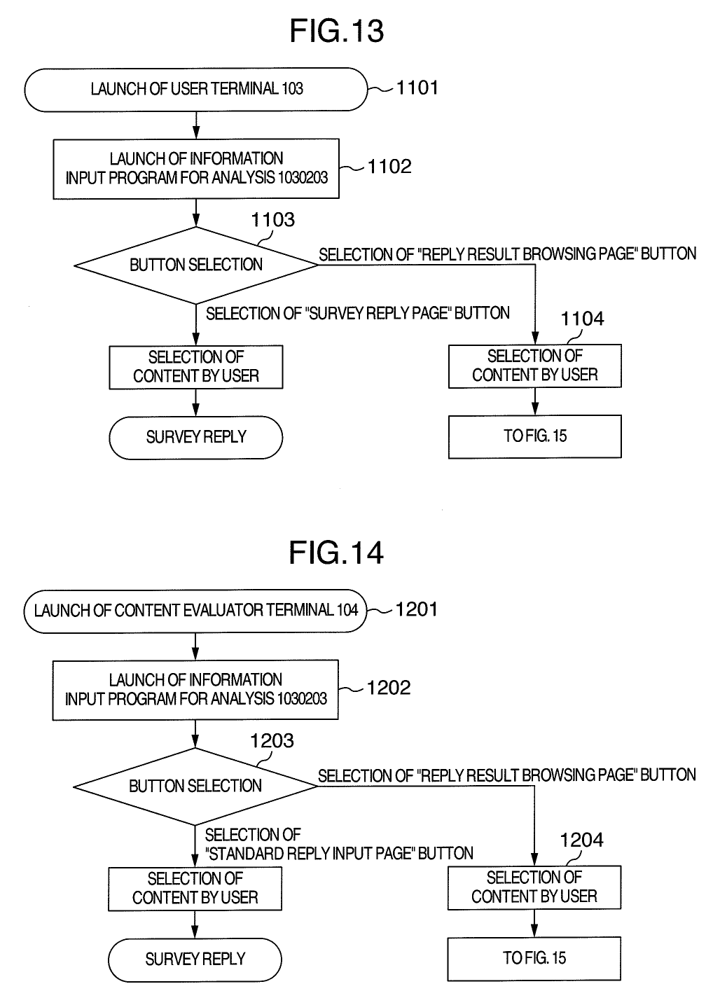

As for the content under consideration, there are chosen two types of content, e.g. Web format content and digital pen compatible paper based content. In case the content selected by the user is Web format content, the user first launches a content utilization program and displays a page such as shown in FIG. 6A on user terminal screen 601. Here, in case he carries out a reply with respect to the content, a transition is made to the survey response page if, as shown in FIG. 13, he selects “To Survey Response Page”. In case he has selected “Response Result Browsing Page”, a transition is made to the browsing page. If there is e.g. displayed a content selection menu on the page to which a transition has been made and the user selects a desired content item, the user terminal e.g. invokes a page stored on the hard disk of the data management and analysis server by means of the content utilization program and, through a content management program of the same server, invokes content selected from content data automatically stored on the hard disk of the same server, and makes a display thereof on the user terminal.

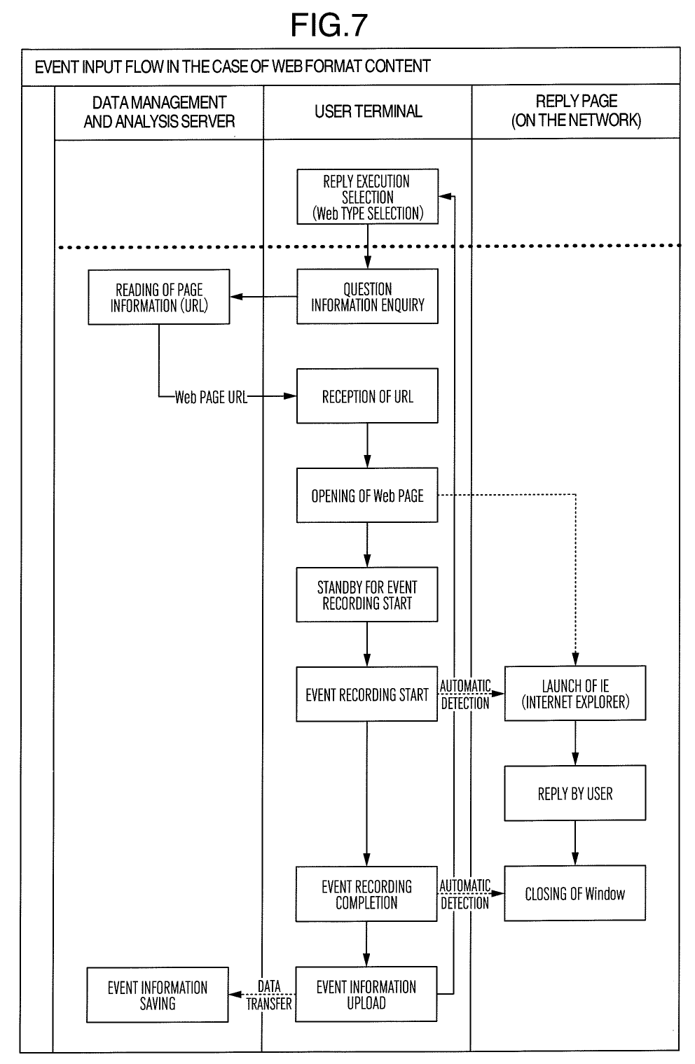

In case the user has selected “To Survey Response Page”, by carrying out a reply on the Web, as shown in FIG. 7, the reply state comes to an end and event collection also comes to an end. The recording of an event that is input by the user via a mouse and a keyboard is carried out by means of the user terminal's information input program for analysis. When replies come to an end and Web content comes to an end, the input user event data are automatically transmitted to the data management and analysis server by means of the data transmission and reception control program. Together with transmission to the server, the user event data can also be left stored on the hard disk.

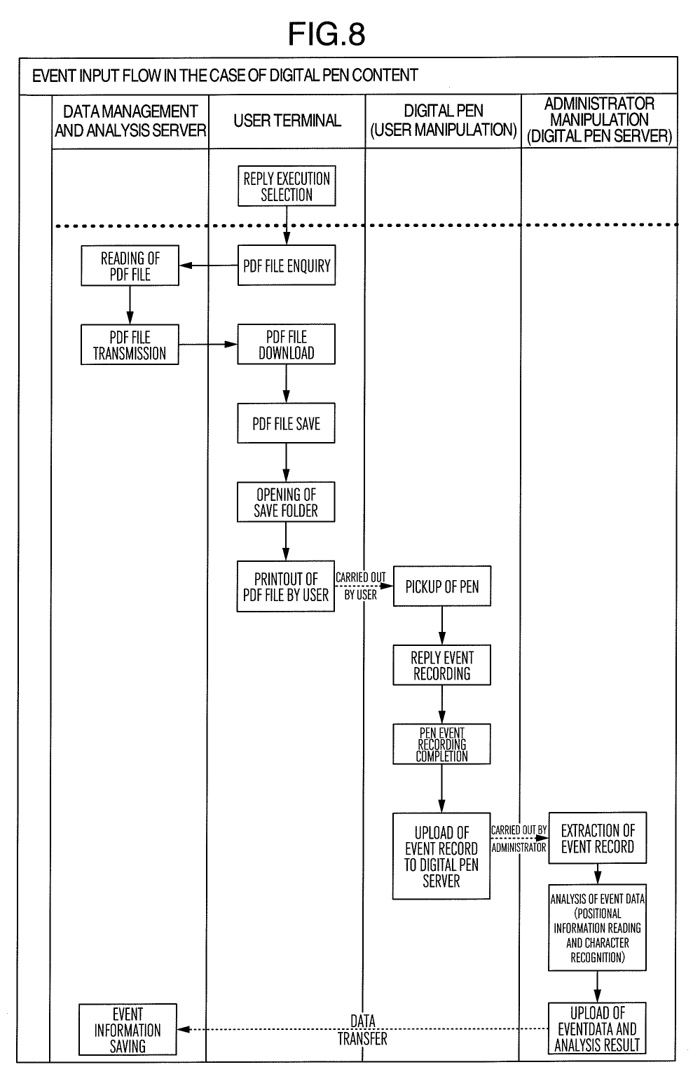

On the other hand, even in the case of application to paper-based content for which a digital pen has been utilized, the initial steps, being the same as in FIG. 13, are, after selecting the content, to download PDF files on a PC and carry out printing, respond using a digital pen, and terminate the response, as shown in the flow of FIG. 8.

The recording of an event input through the digital pen by the user is carried out by the digital pen and the digital pen server. If the digital pen utilized during entry is stored in a digital pen box connected with the user terminal, the event information stored in the digital pen is recorded in the digital pen server via the user terminal. Thereafter, the administrator extracts user input event data from the digital pen server and registers the same in the data management and analysis server. A pen ID identifying the user is registered in advance in the data management and analysis server and treated as data similar to user identification at login.

Also, the content evaluator can input standard input data from the content evaluator terminal. This is carried out, as explained previously, in case accuracy information such as for tests is needed or in case it is desired to observe the scattering of standard replies in surveys.

As for the input method, which is the same as for the input to the user terminal, the content evaluator launches a content utilization program and if, as shown in FIG. 6B and FIG. 14, he selects “To Standard Reply Input Page”, a content selection menu is displayed and if he selects content for which the user carries out standard input, the corresponding content is selected through a content management program of the data management and analysis server, and the content is displayed on the content evaluator terminal. In addition, even in the case of digital pen input, the flow is the same as for input to the user terminal.

It is e.g. identified with a login ID whether the user is a user replying to content or a content evaluator. Moreover, the input standard reply can also be registered as several individual files.

Hereinafter, a description will be given regarding an estimation method of the user input event generation field which is a position of information input by the user. In the server, there is launched a user event data analysis program. The user event data analysis program uses user input event data accumulated by means of a data accumulation program to carry out an analysis.

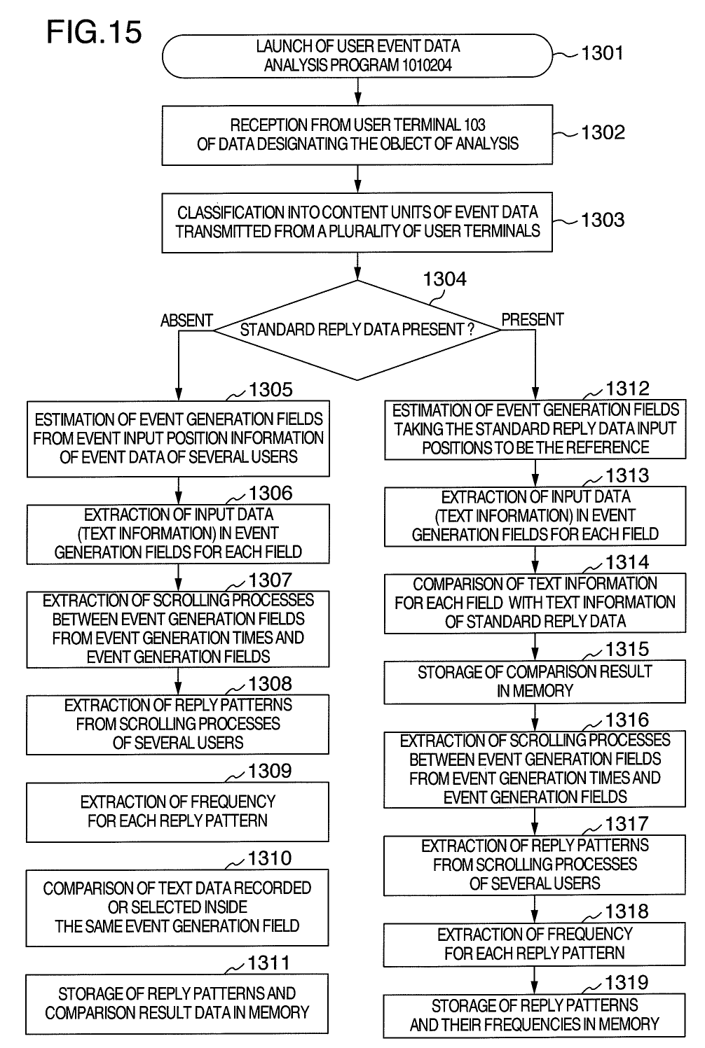

As shown in FIG. 15, first, the data management and analysis server receives data designating the object of analysis from user terminal 103 and classifies event data transmitted in content units from a plurality of user terminals. Here, a classification is carried out by means of the user ID and a content ID given to the content. Next, it is judged whether there are standard responses or not.

In case there is no standard response, the information input position is estimated from event input positional information of the event data of several users. It is e.g. conducted according to the sequence hereinafter.

E.g., in case there is a difference, between event input time n and input time n+1, of 2 seconds or more as an average over several user event data items, and in case the data of several users are superposed in page fields, the approximate distance (p[i]-p[i-1]) of the positions p(x,y) of the event input at event input time n is taken to be the maximum page field; e.g. in case it is on average 2 cm wide or 3 cm long or more, and there is taken to be an inter-question gap between n and n+1, the number of questions is estimated to be (number of gaps m)+1 (0-j). Further, the coordinate value of the beginning edge of the reply input, with respect to each of the estimated questions, and the coordinate value of the ending edge of the reply, with respect to each of the questions substituted for n, are stored by association with Question [i=0-m]. Alternatively, in case the mouse click position and the coordinate position of the beginning edge of the keyboard entry are the same, it is estimated that there is an event generation field in the corresponding position. Further, the processes of scrolling between event generation fields are extracted from the event generation times and the event generation fields, the corresponding input data and scrolling processes being stored in memory. Next, the frequency is extracted for each reply pattern from the stored scrolling process data of several users and, the text data recorded or selected within identical event generation fields are compared, and the same comparison data are stored in memory together with reply patterns with frequencies conferred.

Next, a description will be given regarding an estimation method for information input positions in the case where there is a standard pattern. There is carried out an estimation of event generation fields using input standard patterns and several user input event data. First, there is carried out a comparison of the matching of the input event coordinate values of the user input event data and the input event coordinate values occurring in each question of the standard pattern and each reply position of the user is estimated. As a result of the comparison matching, a coordinate value that conforms to the coordinate value of the beginning edge of the response of the standard pattern and the coordinate value of its ending edge is estimated to be the beginning and ending edges of the reply. Next, in order to judge the reply content scattering and reply accuracy among several users, the input data (text information) in the estimated event generation fields are extracted for each field. Further, the scrolling processes between the event generation fields are extracted from the event generation times and the event generation fields and the concerned input data and scrolling processes are stored in memory. Next, a frequency is extracted for each reply pattern from the stored scrolling process data of several users, text data recorded or selected in the same event generation field are compared with data recorded in the same fields in standard input, and the same comparison data are stored in memory together with the reply data with frequencies conferred.

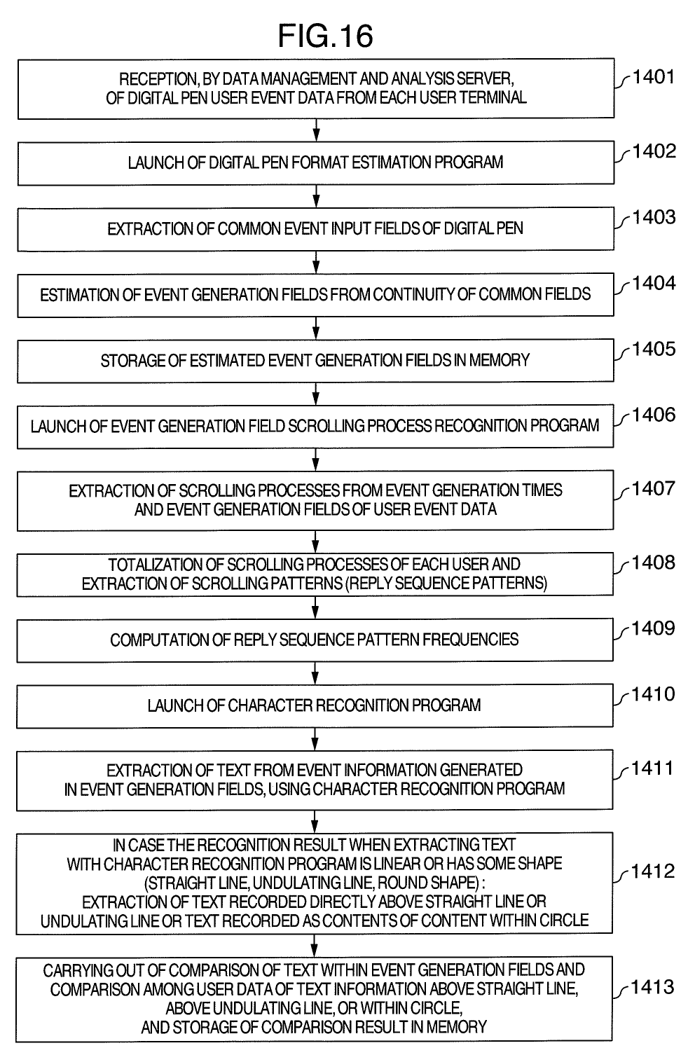

Moreover, in the case of utilizing a digital pen, as shown in the flow of FIG. 16, the data management and analysis server transmits the user event data of the digital pen from each user terminal. At this time, a digital pen format estimation program is launched, the input user input event data of the digital pen are analyzed, and format estimation is carried out.

At the outset, the common event input fields of the digital pen are extracted by superposing the input event data of several users. From the continuity of the common fields, the event generation fields are estimated. Specifically, the paper fields are e.g. cut and divided into a 1 cm mesh, and by extracting the fields in which mesh elements with superposed event data are included, the event generation fields are estimated. The event generation fields estimated here are stored with coordinate values in memory.

Next, an event generation field scrolling process recognition program is launched and the scrolling processes are extracted from the event generation times and event generation fields of the user event data.

Next, the scrolling processes of each user are totalized, the scrolling patterns (reply sequence patterns) are extracted, and the frequencies of the reply sequence patterns are computed and stored in memory. Next, a character recognition program is launched and, by means of the same program, text is extracted from event information generated in the event generation fields.

Here, when the text is extracted with the character recognition program, in case the recognition result is linear or has some shape (straight line, undulating line, or round shape), text recorded directly above the straight line or undulating line and/or text recorded as the contents of content within the circle is extracted. At the very end, there are carried out a comparison of the text within the event generation fields and a comparison between user data of the text information above the straight line, above the undulating line, or inside the circle, and the comparison results are stored in memory.

Next, the user state is judged using the stored event generation fields (number of questions, reply position), text information within the event generation fields, and text information adjacent to the event generation positions. Here, an example with each of the judgment criteria is shown.

### (No Entry Judgment)

In case there is no entered event coordinate value conforming to the beginning edge and ending edge of event field #1 (Question #1), it is judged that there is no entry.

### (Judgment of Correct Response, Incorrect Response, and Proximity to the Correct Response)

For each question, the input standard pattern and user event are matched by comparison. In the beginning, there is a search for an event or text information that is the same as that of the standard pattern. In case the event or text information of the user event and the standard pattern event are the same, it is judged that there is a “Correct Response” and k[i]=0 is returned for judgment value k[i] and transmitted to the information management and control server. In case a standard pattern event is included within the user event and the same event is present at the ending edge of the user event, it is judged that there is a “Correct Response” and a judgment value k[i]=1 is returned and transmitted to the information management and control server.

On the other hand, in case an event of the standard pattern is included within the user event but no ending edge is present, it is judged that there is a “Hesitant Incorrect Response” and a judgment value k[i]=2 is returned and transmitted to the information management and control server. In case a standard pattern event is not included in the user event, it is judged that there is an “Incorrect Response” and a judgment value k[i]=3 is returned and transmitted to the information management and control server. The aforementioned values and the number of matching comparisons between standard pattern events and the user input events associated with each of the questions/the values h[i] of the number of user input events are registered as values with proximity to the correct response. Moreover, in the case of a digital pen, in case the recognition result is linear or has some shape (straight line, undulating line, or round shape), there is carried out a comparison of the text recorded directly above the straight line or undulating line and text recorded as the contents of content within the circle and “Correct Response” or “Incorrect Response” is judged in the same way as above.

### (Judgment of Response Time)

The difference value d[i] between the difference of the beginning edge and ending edge of the reply of the standard pattern with respect to each question, and the difference between the beginning edge and ending edge of the user reply with respect to each question, is estimated to be the response variation time, taking the standard input time to be the reference value.

With the aforementioned method, an estimation of the input fields and the extraction of response contents and processes are carried out. By carrying out a group tendency and pattern classification from response data obtained from several more content users, the tendency of the user group and the evaluation tendency with respect to each content item are extracted.

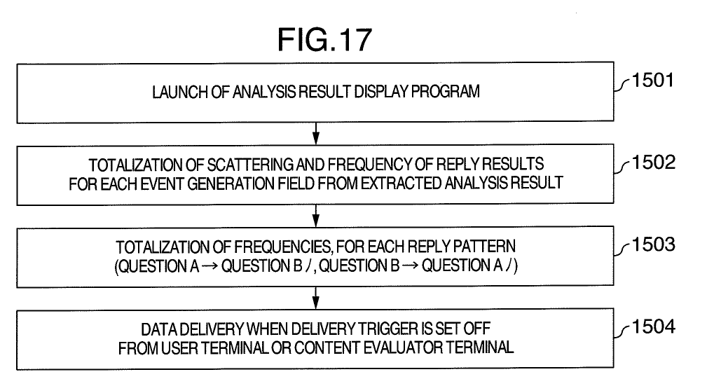

Next, the analysis result is displayed. As described above, the analysis result is, as shown in FIG. 17, converted at the outset into analysis result display data by means of an analysis result display program on the data management and analysis server. First, the analysis result display program is launched and the scattering and frequency of the reply result for each event generation field are totalized from the extracted analysis result. Also, the frequencies for each of the reply patterns (Question A→Question B, . . . , Question B→Question A) are totalized and rearranged as graphic data. At the very end, the aforementioned data are delivered when a delivery trigger is set off from the user terminal and the content evaluator terminal.

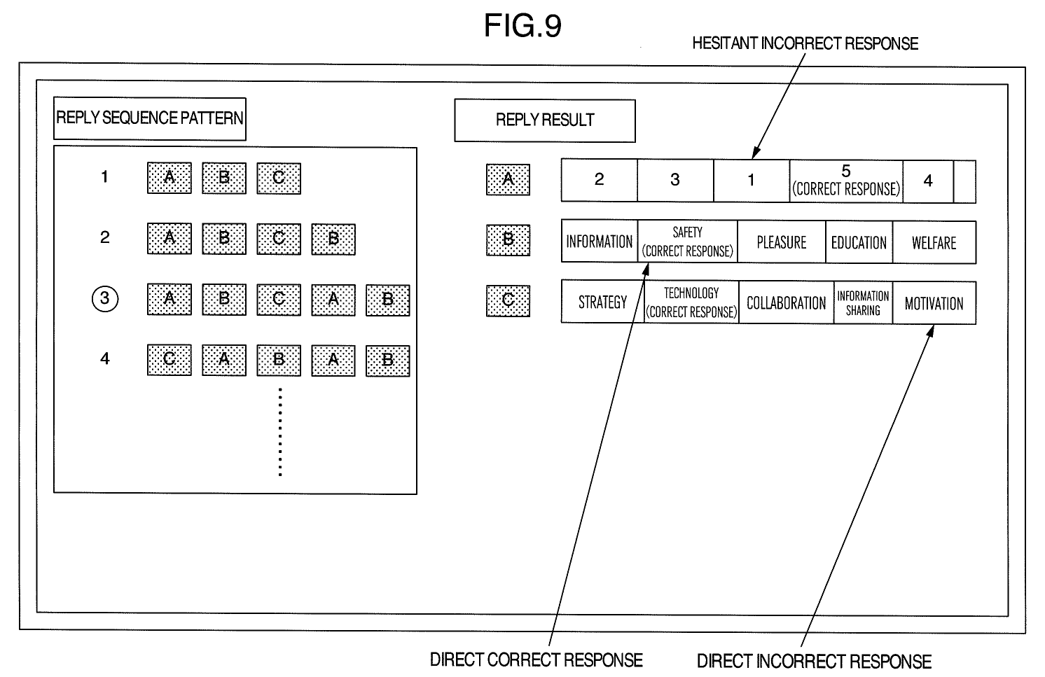

FIG. 9 is a screen displayed on the user terminal at the time of choosing “To Reply Result Browsing Page” in FIG. 6A and selecting desired content from the content selection menu displayed on the page to which a transition has been made. “Reply Sequence Patterns” and “Reply Results” are displayed. A plurality of “Reply Sequence Patterns” are lined up, e.g. in order of frequency. Also, the user reply sequence is e.g. stated clearly with a shape in which the numbers conferred to the patterns are enclosed. As for the reply result, the reply types with respect to each question and survey are lined e.g. in order of frequency. For correct responses or standard replies, there is underneath the mention “Correct Response” or “Standard Reply”.

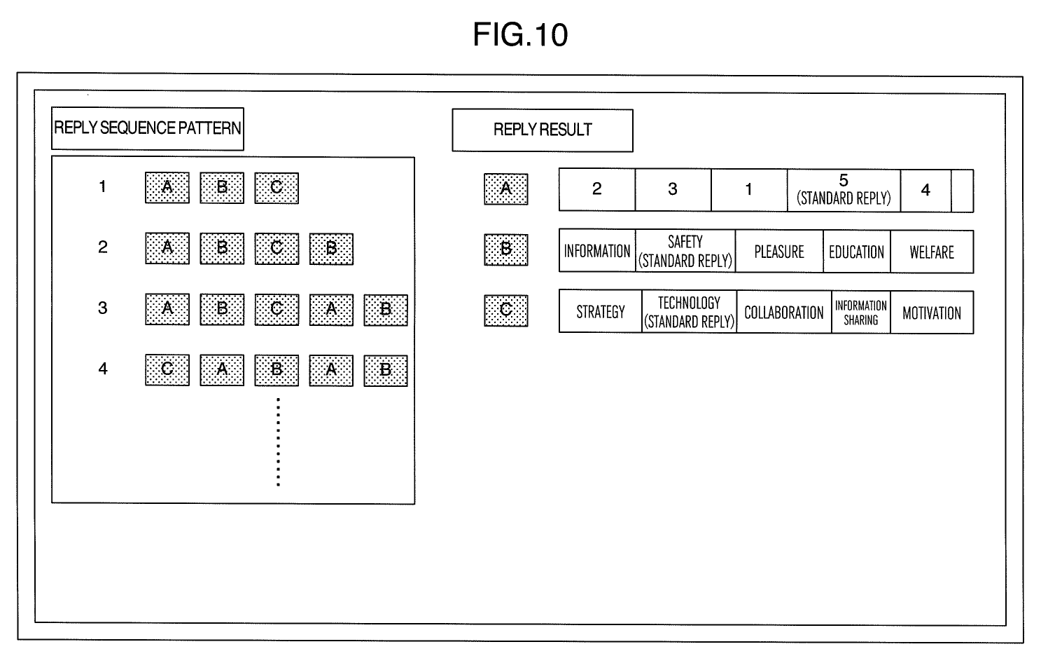

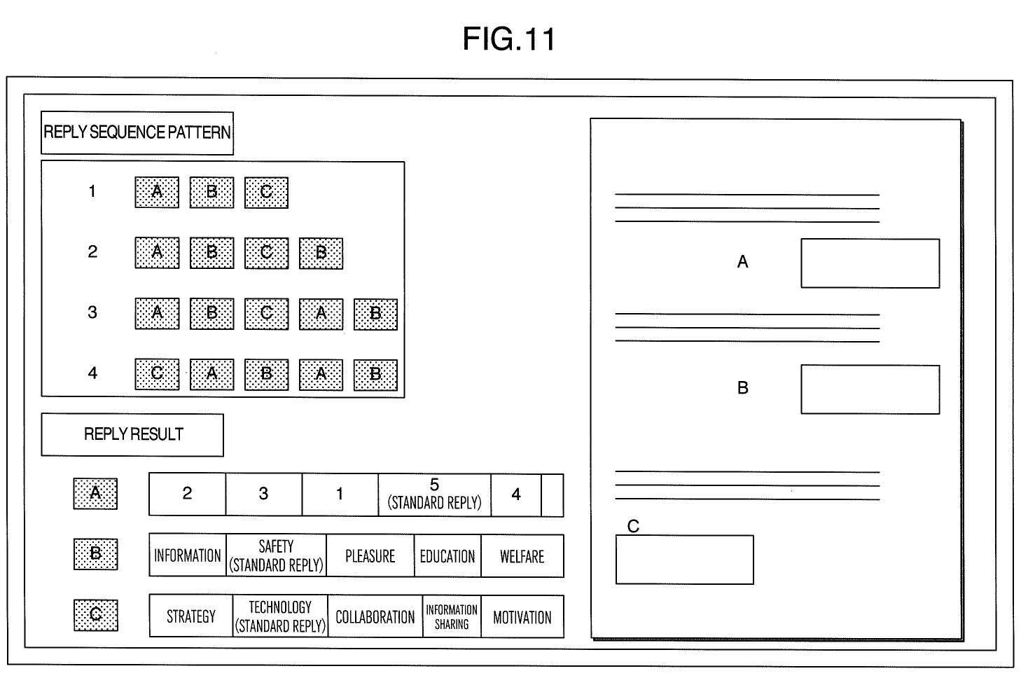

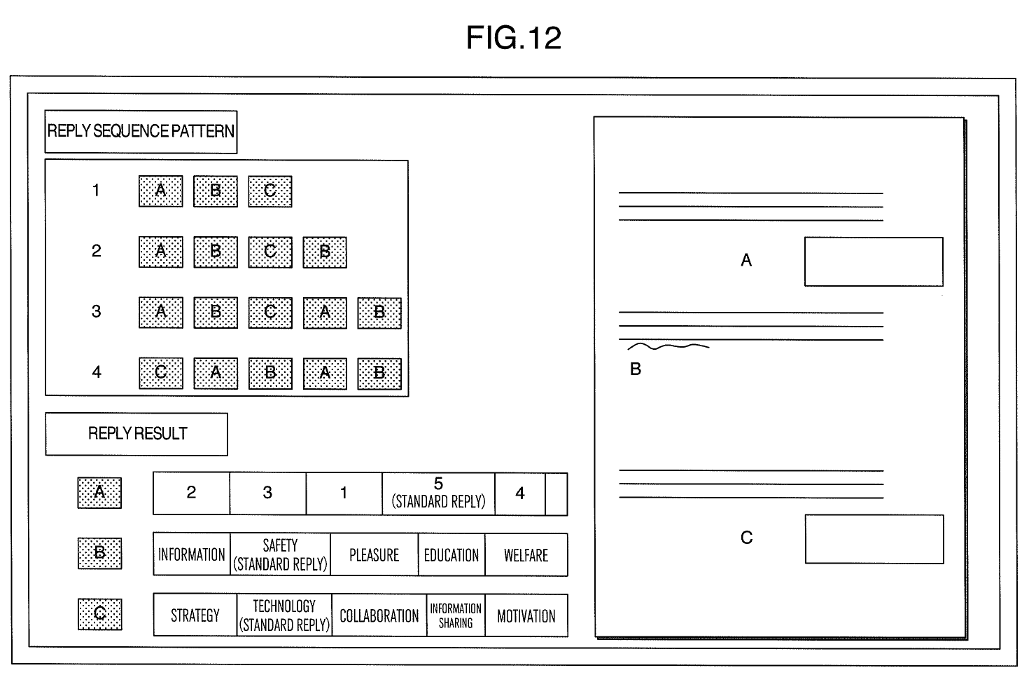

As for the replies of the user himself, they are e.g. colored in the same reply display fields. Further, the reply processes of individual questions and surveys (direct correct response, hesitant correct response, direct error, hesitant error) are displayed by means of image patterns (oblique line, square . . . ). As shown in FIG. 10, the same display is carried out on the content evaluator terminal as well. Also, in the case of lining up the content and the analysis result together, symbols (here A, B, . . . ) indicating each of the questions are, as shown in FIG. 11, displayed on the screen in the positions estimated as the user event generation fields, together with “Reply Sequence Patterns” and “Reply Results” such as shown above. Also, as shown by “B” in FIG. 12, regarding data which are linear or have a wavy shape or a round shape, the handwritten data are displayed utilizing a digital pen, below the text of the concerned data and on the basis of the coordinate values of the event data.

It should be further understood by those skilled in the art that although the foregoing description has been made on embodiments of the invention, the invention is not limited thereto and various changes and modifications may be made without departing from the spirit of the invention and the scope of the appended claims.

1. An information recognition system comprising:
first input means for inputting a plurality of data in a first terminal displaying a content format concerned by the input;
storage means for storing said input plurality of data;
means for computing the similarity values or difference values among said input plurality of data, and computing the similarity values and difference values between data input as standard input or model input by means of a second input means, of a second terminal, and said plurality of data; and
means for estimating, from said computation result, the information input positions of said plurality of data in said content format.

2. The information recognition system according to claim 1, comprising means for estimating correct response input positions and incorrect response input positions from the similarity values and difference values between information about the information input positions of said extracted plurality of data, and input position information of said input plurality of data.

3. The information recognition system according to claim 1, comprising means for estimating correct response values and incorrect response values from the similarity values and difference values between information about the information input positions of said extracted plurality of data, and input position information of said input plurality of data.

4. The information recognition system according to claim 1, comprising means for estimating the types of incorrect response values from the similarity values and difference values between the input content information of data input as said standard input or model input, and the input content information of said input plurality of data.

5. The information recognition system according to claim 1, comprising means for storing the coordinate position data and input times of data input by means of said first input means, and wherein:
the number of accesses to each input position of the format is computed from the difference values between the input time information about the input positions of data input as standard input or model input and input times by means of said second input means, and the input time information about the input positions of a plurality of input data input by means of said first input means.

6. The information recognition system according to claim 1, comprising:
means for storing coordinate position data and input times by means of said first input means; and
means for extracting the access sequence tendency to each input position of the format from the difference values between input time information about the input positions of data input as standard input or model input by means of said second input means, and the input time information about the input positions of a plurality of input data input from said first input means.

7. The information recognition system according to claim 1, comprising means for computing the access time to each input position from the estimated information input positions within said content format and input time information about input positions obtained by a means storing the coordinate position data and input times input by means of said first input means.

8. The information recognition system according to claim 1, comprising means for estimating the text contents indicated by continuous input position data groups from estimated information input positions within said content format, coordinate position data input by means of said first input means, the continuity of the input positions of input data obtained by means for storing input times, and display positions of text recorded in said content format.

9. The information recognition system according to claim 1, comprising means for displaying the result of analyzing said plurality of data input by means of said first terminal in the order of same vocabulary word frequency and in the pattern order of the input processes.
